(19) United States
(12) Patent Application Publication
(10) Pub. No.: US 2024/0226981 A1
(43) Pub. Date: Jul. 11, 2024

(54) DEVICE FOR FLATTENING BATTERY CELL ELECTRODE TAB

(71) Applicant: HUIZHOU YINGHE SMART TECHNOLOGY CO., LTD, Huizhou (CN)

(72) Inventors: GENFA LI, Huizhou (CN); JIAYUAN HUANG, Huizhou (CN); ERTIAN LUO, Huizhou (CN); YUEKAI WU, Huizhou (CN); QIZHANG WU, Huizhou (CN)

(21) Appl. No.: 18/615,129

(22) Filed: Mar. 25, 2024

Related U.S. Application Data
(63) Continuation of application No. PCT/CN2023/101271, filed on Jun. 20, 2023.

(30) Foreign Application Priority Data
Aug. 29, 2022 (CN) 202211050491.1

(51) Int. Cl. B21D 19/04; H01M 10/04; H01M 50/533

(52) U.S. Cl. CPC B21D 19/043; H01M 10/0431; H01M 50/533

(57) ABSTRACT

A device for flattening a battery cell electrode tab is provided, which includes a frame, a battery cell clamping mechanism provided on the frame, and a flattening unit provided on two sides of the battery cell clamping mechanism. The present disclosure can adjust an angle and position of a flattening component, which can adapt to different electrode tabs of an inner ring and outer ring of a battery cell coil and different sizes of the battery cell coil. It is more flexible to use, has better a forming effect for the electrode tab, wider application range, and more convenient to operate and adjust, thereby effectively improving a processing and forming efficiency of the electrode tab.

### CROSS-REFERENCE TO RELATED APPLICATIONS

This application is a continuation of International Application No. PCT/CN2023/101271, filed on Jun. 20, 2023, which claims priority to Chinese Patent application Ser. No. 202211050491.1, filed on Aug. 29, 2022. The disclosures of the aforementioned applications are hereby incorporated by reference in their entireties.

### TECHNICAL FIELD

The present disclosure relates to the field of battery cell processing device technologies, and in particular, to a device for flattening a battery cell electrode tab.

### BACKGROUND

The power battery industry is still developing rapidly, the most widely used field of the power battery is the field of new energy vehicles. With a continuous updating of new energy vehicle technology, better requirements have been put forward for energy storage, safety, and charging performance of new energy vehicles to meet people's higher needs. A main energy storage function in the power battery is the battery cell, during a processing process of the battery cell, an electrode tab is needed to be cut at two sides of an electrode sheet, then, the electrode sheet is wound into a battery cell coil, the electrode tab at two ends of a wound cylindrical battery cell coil is in an unfolded state. During the processing process, the electrode tab needs to be pressed into a shape. There are many pressing modes in current technical solution, different shaped forming plates are used to apply a force to the electrode tab, so that the electrode tab can be closed inward. However, due to different angles required for electrode tabs at an outer ring and inner ring, if a forming mechanism does not make an appropriate adjustment and presses the outer and inner rings at a same angle, it will cause directions of the electrode tabs of the inner and outer rings after pressing are inconsistent, an overall pressing-and forming of the electrode tab is disorderly and staggered, which fails to meet the requirement; or some adjustment mechanisms only adjust a position of a flattening component by moving it back and forth, which cannot flexibly adjust the angle so as to match the electrode tabs at different positions on the battery cell coil, the overall forming effect of the electrode tab is not good, and it is not convenient and flexible to use. For example, a flattening device for a battery cell electrode tab has been disclosed in the prior art, which includes a battery clamping device and a flattening device, the flattening device can move in a direction close to or away from the battery clamping device. The flattening device is provided with a flattening head component. The flattening head component can feed along a radial direction parallel to a pre-flattened end face of the battery cell coil with a full electrode tab, the battery clamping device and the flattening device can rotate relative to each other, so that the flattening head component can gradually press the electrode tab on the battery cell coil with full electrode tab from outside the inside. The flattening head component can only move and rotate radially along an end face, but cannot adjust an angle of the flattening head component to flexibly adapt to the electrode tabs at different positions on the inner and outer rings; and sometimes, after a single press, a slight angle rebound of the electrode tab may exists, this device can perform a second tighter pressing and forming by adjusting the angle; thus, the overall forming effect of the electrode tab is poor.

### SUMMARY

The present disclosure aims to overcome the problem that an adjustment mechanism described in the background technology can only adjust a position of a flattening component forward and backward, cannot flexibly adjust an angle to match electrode tabs at different positions on a battery cell coil, an overall forming effect of the electrode tab is poor, it is not convenient and flexible to use. A device for flattening a battery cell electrode tab is provided. The present disclosure can flexibly adjust a position and angle of a flattening component, rendering it more flexible and convenient to use.

To solve the above-mentioned technical problems, the technical solution adopted by the present disclosure is to provide a device for flattening a battery cell electrode tab, which includes a frame, a battery cell clamping mechanism provided on the frame, and a flattening unit provided on two sides of the battery cell clamping mechanism;

the flattening unit includes:

a guide rail,

a sliding support,

a flattening mechanism,

a first drive mechanism, configured to drive the sliding support to move along the guide rail to approach or move away from the battery cell clamping mechanism;

a second drive mechanism, configured to drive a rotation shaft to rotate and drive a flattening mechanism to rotate;

a third drive mechanism, configured to drive a sliding sleeve to move along the rotation shaft to adjust an angle of the flattening mechanism;

the first drive mechanism is connected to the sliding support, the sliding support is slidably connected to the guide rail, the second drive mechanism is provided on the sliding support and connected to the flattening mechanism.

In an embodiment of the present disclosure, the flattening mechanism includes a flattening component, a rotating component, and a movable component, configured to adjust an angle of the flattening component; the rotating component includes the rotation shaft and a connection plate, the movable component includes the sliding sleeve, a connection rod, and an adjustment block, the sliding sleeve is movably sleeved on the rotation shaft, one end of the connection rod is twisted with an outer wall of the sliding sleeve; the third drive mechanism is connected to the sliding sleeve, the connection plate and the adjustment block are both L-shape; one side of the connection plate is connected to one end face of the rotation shaft, the other end of the rotation shaft is connected to the second driving mechanism, a U-shaped opening is provided on the other side of the connection plate; the adjustment block includes a bottom plate and a side plate; one end of the side plate that is far away from the bottom plate is hinged with the other end of the connection rod, two sides of the bottom plate that are connected to the side plate are rotationally connected to two inner walls of the U-shaped opening, the flattening component passes through the U-shaped opening and is installed on the bottom plate of the adjustment block.

In an embodiment of the present disclosure, the connection rod is a U-shaped connection rod, two sides of an end of the side plate that is far from the bottom plate are rotatably connected to the two inner walls of an opening end of the U-shaped connection rod, respectively; an outer wall of a sealing end of the U-shaped connection rod is provided with a bending connection part that is hinged with the outer wall of the sliding sleeve.

In an embodiment of the present disclosure, the flattening component includes a flattening motor and a flattening cone wheel, a base of the flattening motor is fixedly provided on the bottom plate, an output shaft of the flattening motor passes through the bottom plate and is connected to the flattening cone wheel.

In an embodiment of the present disclosure, the first drive mechanism includes a first motor, a first belt transmission component, a transmission threaded rod, and a transmission shaft, a base of the first motor is provided on the frame, an output shaft of the first motor is connected to a pulley at one end of the first belt transmission component, a pulley at the other end of the first belt transmission component is fixedly connected to one end of the transmission threaded rod, two ends of the transmission shaft are connected to a support on the frame; the transmission shaft is parallel to the transmission threaded rod, the sliding support is thread connection to the transmission threaded rod; the sliding support is movably sleeved on the transmission shaft.

In an embodiment of the present disclosure, the second drive mechanism includes a second motor, a second belt transmission component, and a third belt transmission component; a base of the second motor is fixed on the frame, an output shaft of the second motor is connected to a pulley at one end of the second belt transmission component, the transmission shaft passes through the support on a corresponding side and is connected to a pulley at the other end of the second belt transmission component, a pulley at one end of the third belt transmission component is movably sleeved on the transmission shaft, the third belt transmission component is provided on one side of the sliding support near the second belt transmission component, a pulley at the other end of the third belt transmission component is fixedly connected to one end of the rotation shaft away from an adjustment plate, the rotation shaft passes through the sliding support, a middle of the rotation shaft is rotatably connected to the sliding support.

In an embodiment of the present disclosure, the third drive mechanism includes a third motor, an adjustment threaded rod, and the adjustment plate, one side of the sliding support that is opposite to the flattening mechanism is provided with a motor bracket, a base of the third motor is fixed on the motor bracket, an output shaft of the third motor is connected to one end of the adjustment threaded rod, the other end of the adjustment threaded rod is thread connection to the adjustment plate; one side of the adjustment plate is rotatably connected to the sliding sleeve, an output shaft of the third motor is parallel to the rotation shaft.

In an embodiment of the present disclosure, the other end of the adjustment threaded rod is further provided with a limit structure configured to limit the adjustment plate.

In an embodiment of the present disclosure, the outer wall of the sliding sleeve is provided with an annular groove, one side of the adjustment plate is provided with an arc-shaped notch, the arc-shaped notch is sleeved on the annular groove and rotatably connected to the outer wall of the sliding sleeve.

In an embodiment of the present disclosure, the battery cell clamping mechanism includes a clamping cylinder, a support block, and a clamping block that cooperates with the support block to clamp the battery cell, the clamping cylinder is provided on the frame, a telescopic rod of the clamping cylinder is connected to the clamping block, the clamping block faces to the support block.

Compared to existing technology, the beneficial effects are:

The device for flattening a battery cell electrode tab designed in the present disclosure has an ingenious structural design. A flattening mechanism can flexibly adjust an angle that is subjected on a flattening component through an angle adjustment and rotation, which can effectively flatten different positions and states of the electrode tab; by separate driving effects of a first drive mechanism, a second drive mechanism, and a third drive mechanism, the flattening component is driven to adjust its position in different dimensions. Especially, the second drive mechanism and the third drive mechanism can cooperate with a special structure of the flattening mechanism to adjust the position and angle of the flattening component separately. Thus, it can adapt to different electrode tabs on an inner ring and outer ring of a battery cell coil, and different sizes of the battery cell coil, it is more flexible to use, with a better forming effect and wider application range, and more convenient to operate and adjust, thereby effectively improving a processing and forming efficiency of the electrode tab.

### BRIEF DESCRIPTION OF DRAWINGS

FIG. 1 is a schematic diagram of a front side of Embodiment 1.

FIG. 2 is a schematic diagram of an overall structure of Embodiment 1.

FIG. 3 is a schematic diagram of a side view of Embodiment 1.

FIG. 4 is a structural schematic diagram of a flattening mechanism in Embodiment 1.

FIG. 5 is a schematic diagram of Embodiment 1 when flattening an electrode tab of an outer ring.

FIG. 6 is a schematic diagram of Embodiment 1 when flattening an electrode tab of an inner ring.

### DESCRIPTION OF EMBODIMENTS

The drawings are for illustrative purposes only and cannot be understood as a limitation on the present disclosure. In order to better illustrate this embodiment, certain components in the drawings may be omitted, enlarged or reduced, which does not represent an actual size of a product. For those skilled in the art, it is understandable that some well-known structures and their explanations in the drawings may be omitted. A description of a positional relationship in drawings is only for illustrative purposes and cannot be understood as a limitation on the present disclosure.

The same or similar symbols in the drawings of the embodiments of the present disclosure correspond to the same or similar components; in the description of the present disclosure, it should be understood that if there are terms such as “up”, “down”, “left”, “right”, “long”, “short” indicating an orientation or position relationship based on an orientation or position relationship shown in the drawings, it is only for a convenience of describing the present disclosure and simplifying the description, and not to indicate or imply that a device or element referred to must have a specific orientation, be constructed and operated in a specific orientation. Thus, terms used to describe the positional relationship in the drawings are only for illustrative purposes and cannot be understood as restrictions on the present disclosure. For ordinary technical personnel in this field, specific meanings of the above terms can be understood based on a specific circumstance. In addition, terms “first”, “second”, “third”, etc. are only used to describe a purpose and cannot be understood as indicating or implying a relative importance. “Vertical” is not strictly vertical, but within an allowable range of error. “Parallel” is not strictly parallel, but within the allowable range of error.

The battery cell in the embodiment of the present disclosure, when it is wound into a coil, has a continuous electrode tab circle after circle at two ends of the batter cell, and the electrode tab needs to be flattened. The battery cell referred to in the present application can be those used in a production process of an automotive power battery, or those used in a production process of other lithium batteries.

In the embodiment of the present disclosure, a belt transmission component (including a first belt component, a second belt component, and a third belt component) in the present disclosure refers to a mechanism component of a belt transmission in the prior art, which is composed of two pulleys and a set of belts. A size and dimension can be adaptively adjusted according to a corresponding position.

In the description of the present application, it should also be noted that unless otherwise specified and limited, terms “installation”, “connection to”, and “connection with” should be broadly understood. For example, a specific relationship represented can be a fixed connection, a detachable connection, or an integrated connection; it can be a direct connection, or indirect connection through an intermediate medium, or it can be an internal connection between two components. For ordinary technical personnel in this field, they can understand the specific meanings of the above terms in the present application based on the specific circumstance.

The following provides a further detailed description of the technical solution of the present disclosure through specific embodiments and in combination with the drawings.

### Embodiment 1

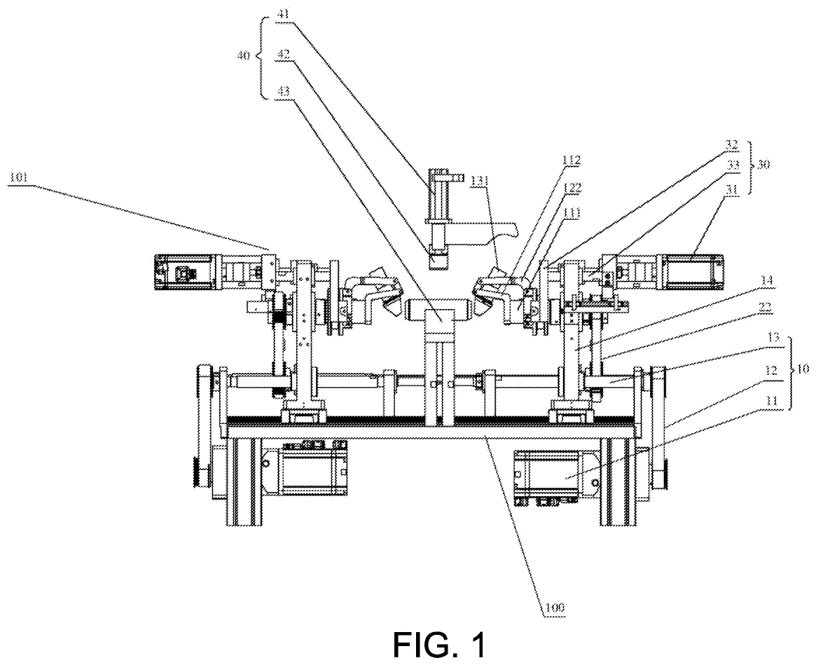

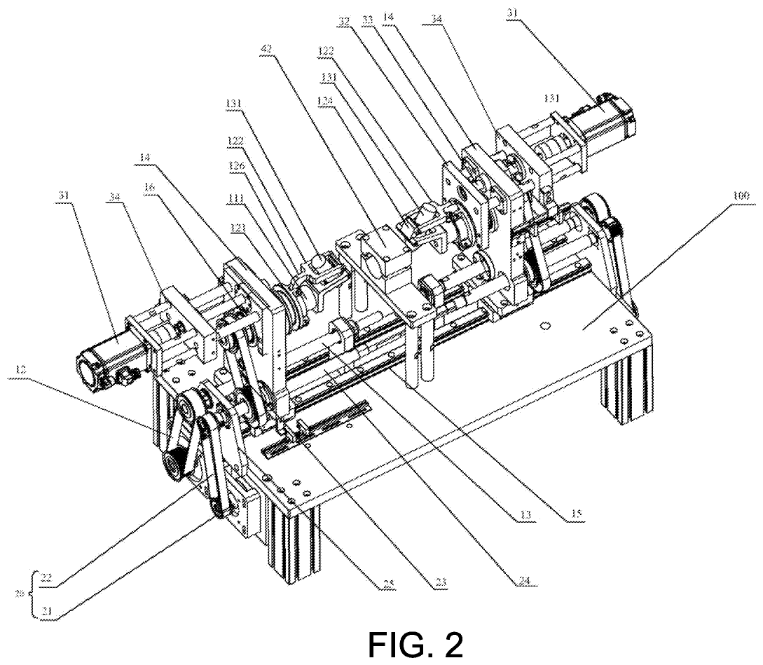

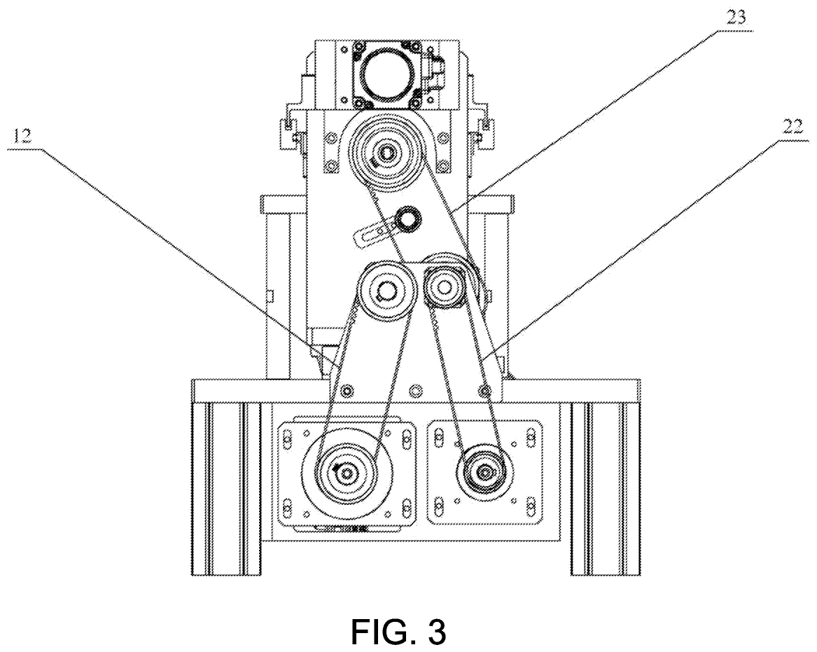

This embodiment is a device for flattening a battery cell electrode tab, referring to FIGS. 1 to 3, which includes a frame 100, a battery cell clamping mechanism 40 provided on the frame 100, and a flattening unit 101 provided on two sides of the battery cell clamping mechanism 40. The flattening unit 101 includes a guide rail 15, a sliding support 14, a first drive mechanism 10 configured to drive the sliding support 14 to move along the guide rail 15 to approach or move away from the battery cell clamping mechanism 40; a second drive mechanism 20 configured to drive a sliding sleeve 121 to rotate along a rotation shaft 111 and drive a flattening mechanism to rotate; and a third drive mechanism 30 configured to drive the rotation shaft 111 to move along the sliding sleeve 121 to adjust an angle of the flattening mechanism. The first drive mechanism 10 is connected to the sliding support 14, the sliding support 14 is slidably connected to the guide rail 15. The second drive mechanism 20 is provided on the sliding support 14 and connected to the flattening mechanism. In this way, the flattening unit 101 on the two sides have a same structure and are symmetrically provided. When a forming operation is required, the battery cell 200 reaches to the battery cell clamping mechanism 40 and is clamped. The first drive mechanism 10 drives the sliding support 14, which in turn drives the flattening mechanism to approach the battery cell coil 200. The second drive mechanism 20 drives the rotation shaft 111 to rotate, which in turn drives the entire flattening mechanism to rotate in a vertical plane. The third drive mechanism 30 drives the sliding sleeve 121 to move, the angle of the flattening mechanism can be adjusted by adjusting a rotation of the second drive mechanism 20 and an angle of a flattening cone wheel 132 through the third drive mechanism 30. The position and angle of the flattening mechanism can be adaptively adjusted to match the battery cell electrode tabs in different positions and states.

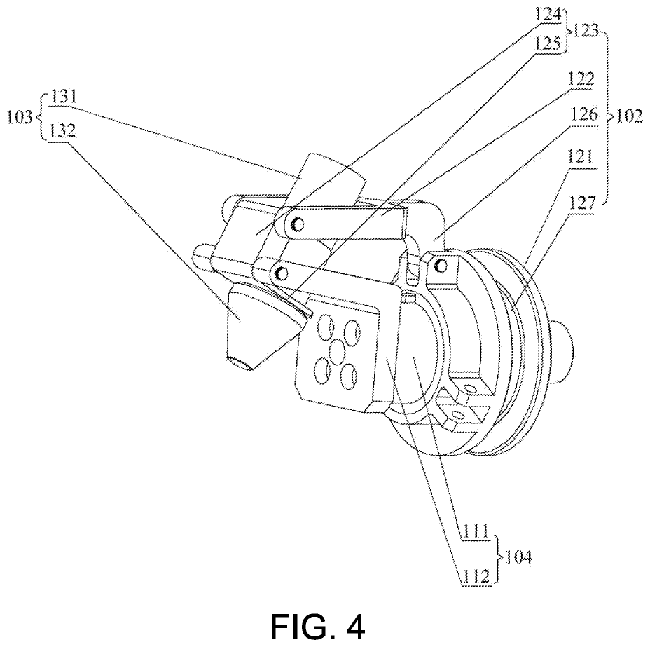

Referring to FIG. 4, the flattening mechanism in this embodiment includes a flattening component 103, a rotating component 104, and a movable component 102 configured to adjust an angle of the flattening component 103. The rotating component 104 includes a rotation shaft 111 and a connection plate 112. The movable component 102 includes the sliding sleeve 121, a connection rod 122, and an adjustment block 123. The sliding sleeve 121 is movably sleeved on the rotation shaft 111, one end of the connection rod 122 is twisted with an outer wall of the sliding sleeve 121. The connection plate 112 and the adjustment block 123 are both L-shaped structures. One side of the connection plate 112 is fixedly connected to one end face of the rotation shaft 111, a U-shaped opening is provided on the other side of the connection plate 112. The adjustment block 123 includes a bottom plate 125 and a side plate 124. One end of the side plate 124 that is far away from the bottom plate 125 is hinged with the other end of the connection rod 122. Two sides of the bottom plate 125 that are connected to the side plate 124 are respectively rotationally connected to two inner walls of the U-shaped opening. The flattening component 103 passes through the U-shaped opening and is installed on the bottom plate 125 of the adjustment block 123. In this embodiment, the two sides of a middle corner position of the L-shaped adjustment block 123 are hinged with the connection plate 112 at a front end of the rotation shaft 111, and the two sides of a top end of the L-shaped adjustment block 123 are hinged with the connection rod 122. The movable component 102 can move relative to the rotation shaft 111 under a drive of the third drive mechanism 30, thereby adjusting the angle of the flattening component 103; at the same time, the rotation shaft 111 can also drive the flattening component 103 to rotate under an action of the second drive mechanism 20. By adjusting in two dimensions, the position and angle that is subjected to the flattening component 103 can be flexibly and adaptively adjusted. It can effectively flatten the electrode tabs in different positions and states.

In this embodiment, the flattening component 103 includes a flattening motor 131 and a flattening cone wheel 132. A base of the flattening motor 131 is fixedly provided on the bottom plate 125, an output shaft of the flattening motor 131 passes through the bottom plate 125 and is connected to the flattening cone wheel 132. In this way, a taper of the flattening cone wheel 132 needs to be adapted to the size of the battery coil and the size of the electrode tab. The flattening motor 131 can drive the flattening cone wheel 132 to rotate and apply a radial force towards an axis of the battery cell coil to achieve a flattening of the electrode tab. Based on the electrode tabs at different positions on an outer ring and inner ring of the battery cell coil, an angle between the flattening cone wheel 132 and the battery cell coil can be adjusted to adapt to the flattening forming of the electrode tabs at different positions.

The first drive mechanism 10 includes a first motor 11, a first belt transmission component 12, a transmission threaded rod 13, and a transmission shaft 24. A base of the first motor 11 is provided on the frame 100, an output shaft of the first motor 11 is connected to a pulley at one end of the first belt transmission component 12, a pulley at the other end of the first belt transmission component 12 is fixedly connected to one end of the transmission threaded rod 13, two ends of the transmission shaft 24 are connected to a support 25 on the frame 100. The transmission shaft 24 is parallel to the transmission threaded rod 13, the sliding support 14 is thread connection to the transmission threaded rod 13. The sliding support 14 is also movably sleeved on the transmission shaft 24.

The second drive mechanism 20 includes a second motor 21, a second belt transmission component 22, and a third belt transmission component 23. A base of the second motor 21 is fixed on the frame 100, an output shaft of the second motor 21 is connected to a pulley at one end of the second belt transmission component 22, the transmission shaft 24 passes through the support on a corresponding side and is connected to a pulley at the other end of the second belt transmission component 22, a pulley at one end of the third belt transmission component 23 is movably sleeved on the transmission shaft 24 (the pulley can move along the transmission shaft 24 and can rotate synchronously under a rotation of the transmission shaft 24 due to a connection with a part such as a ball spline), the third belt transmission component 23 is provided on one side of the sliding support 14 near the second belt transmission component 22, a pulley at the other end of the third belt transmission component is fixedly connected to one end of the rotation shaft 111 away from an adjustment plate 32. The rotation shaft 111 passes through the sliding support 14 and a middle of the rotation shaft 111 is rotatably connected to the sliding support 14.

The third drive mechanism 30 includes a third motor 31, an adjustment threaded rod 33, and the adjustment plate 32. One side of the sliding support 14 that is opposite to the flattening mechanism is provided with a motor bracket. A base of the third motor 31 is fixed on the motor bracket. An output shaft of the third motor 31 is connected to one end of the adjustment threaded rod 33, the other end of the adjustment threaded rod 33 is thread connection to the adjustment plate 32. One side of the adjustment plate 32 is flexibly sleeved on the sliding sleeve 121, an output shaft of the third motor 31 is parallel to the rotation shaft 111. The outer wall of the sliding sleeve 121 is provided with an annular groove 127, one side of the adjustment plate 32 is provided with an arc-shaped notch. The arc-shaped notch is sleeved on the annular groove 127 and rotatably connected to the outer wall of the sliding sleeve 121. In this way, the sliding sleeve 121 can rotate relative to the adjustment plate 32, and the adjustment plate 32 can also push the sliding sleeve 121 to move along the rotation shaft 111.

The battery cell clamping mechanism 40 includes a clamping cylinder 41, a support block 43, and a clamping block 42 that cooperates with the support block 43 to clamp the battery cell. The clamping cylinder 41 is provided on the frame 100, a telescopic rod of the clamping cylinder 41 is connected to the clamping block 42, the clamping block 42 faces to the support block 43. The battery cell clamping mechanism 40 limits a movement of the battery cell in the vertical plane to coordinate with the flattening process of the electrode tab.

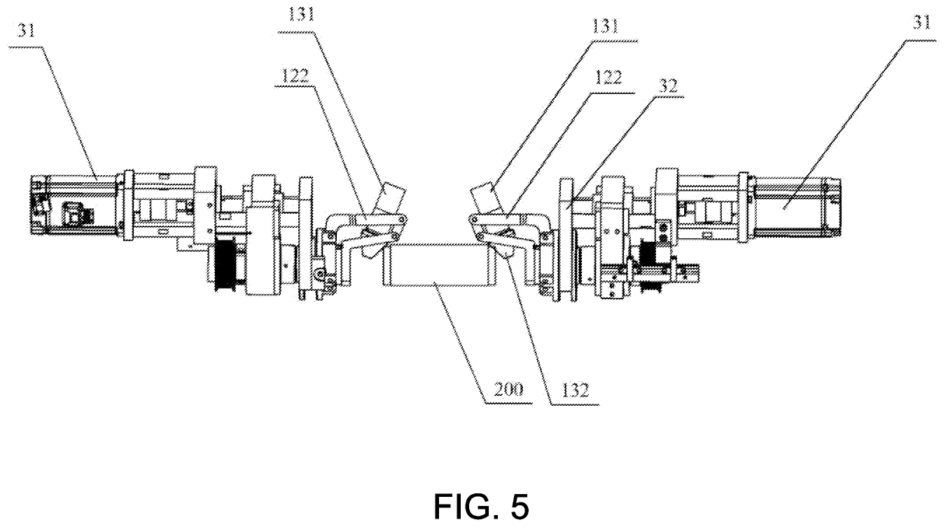

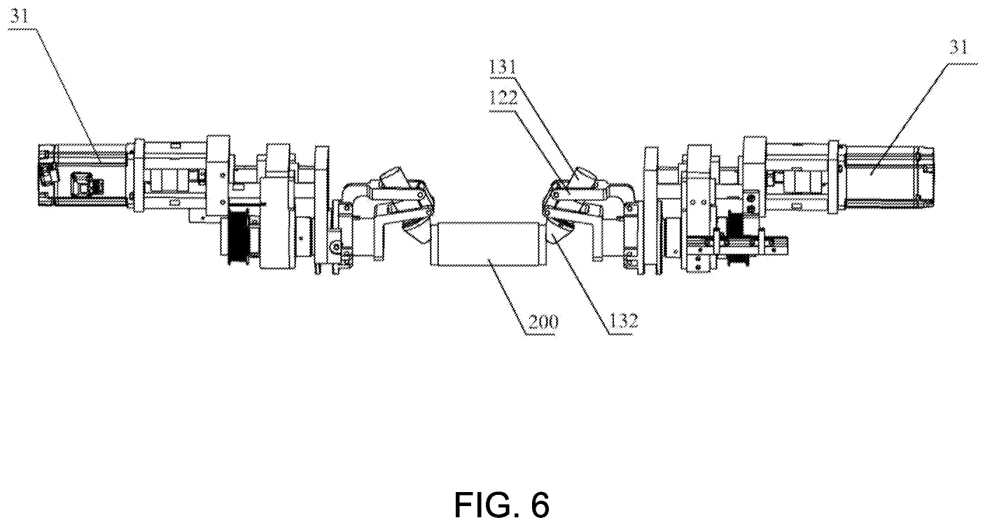

A working principle of this embodiment is as follows: in the first drive mechanism 10, the first motor 11 drives a transmission of the first belt transmission component 12 to drive a rotation of the transmission threaded rod 13. The sliding support 14 moves along the transmission shaft 24 under the transmission of the transmission threaded rod 13 (a connection between the sliding support 14 and the transmission screw is similar to that of a screw slider), the third drive mechanism 30 and the flattening mechanism are both provided on the sliding support 14. Furthermore, it can drive the flattening mechanism to approach the battery cell coil 200. At a beginning, as shown in FIG. 5, a U-shaped connection rod is extended. At this time, a tail of the flattening cone wheel 132 (an end near the flattening motor 131) first contacts the electrode tab of an outer ring of the battery cell. The flattening cone wheel 132 rotates under the drive of the flattening motor 131, and then flattens the electrode tab. The entire flattening mechanism is driven by the second motor 21, which cooperates with the second belt transmission component 22 and the third belt transmission component 32 to drive the flattening component to rotate one circle in the vertical plane, flatten all electrode tab of the outer ring of the battery cell; after flattening the electrode tabs of the outer ring, the second motor 21 keeps rotating, as shown in FIG. 6. The third motor 31 drives the adjustment threaded rod 33 to rotate, the adjustment threaded rod 33 passes through the sliding support 14 and is thread connection to the adjustment plate 32. The two are also equivalent to the screw slider mechanism. A lower side of the adjustment plate 32 is movably connected to the annular groove 127 on the outer wall of the sliding sleeve 121, which is driven by the rotation of the third motor 31, the adjustment plate 32 is driven to move away from the battery cell coil 200, and then the U-shaped connection rod is used to drive an upper end of the flattening component 103 to move backwards. The flattening component 103 rotates and moves continuously, and continuously flatten. At this time, a head of the flattening cone wheel 132 first contacts the battery cell electrode tab (one end away from the flattening motor 131). As the U-shaped connection rod continues to move backwards, the entire cone surface of the flattening cone wheel 132 can adhere to an end face of the electrode tab, it is able to press and flatten the inner ring, and flatten all electrode tab again, after the flattening is completed. The third motor 31 reverses and drives the U-shaped connection rod to retract and reset through the adjustment plate 32, waiting for a next pressing and forming an electrode tab 200 of a battery cell coil.

The device for flattening a battery cell electrode tab designed in this embodiment has an ingenious structural design. Through a separate driving effect of the first drive mechanism 10, the second drive mechanism 20, and the third drive mechanism 30, it drives the flattening component 103 to adjust its position in different dimensions. In particular, the second drive mechanism 20 and the third drive mechanism 30 can cooperate with the special structure of the flattening mechanism to adjust the angle and position of the flattening component 103, respectively, which can adapt to different electrode tab on the inner and outer rings of the battery cell coil, as well as different sizes of the battery cell coil, rendering it more flexible to use. The forming effect of electrode tab is better, an application range is wider, and the operation and adjustment are more convenient, thereby effectively improving a processing and forming efficiency of the pole ear.

### Embodiment 2

This embodiment is another embodiment of Embodiment 1. On the basis of Embodiment 1, in this embodiment, a limit structure is further provided at other end of the adjustment threaded rod 33 to prevent the adjustment plate 32 from exceeding a traveling limit, which can prevent the adjustment plate 32 from moving beyond the traveling limit.

### Embodiment 3

This embodiment is another embodiment of Embodiment 1. Based on Embodiment 1, in this embodiment, the connection rod 122 is a U-shaped connection rod, two sides of the side plate 124 away from the bottom plate 125 are respectively rotatably connected to two inner walls of an opening end of the U-shaped connection rod. The outer wall of a sealing end of the U-shaped connection rod further includes a bent connection part 126 hinged with the outer wall of the sliding sleeve 121. In this way, a width of an opening of the U-shaped connection rod is basically the same as a width of the U-shaped opening on the connection plate 112, ensuring a stability of a connection and the smoothness of a swing.

Obviously, the above embodiments of the present disclosure are only for a purpose of clearly illustrating the embodiments provided herein, and are not limiting the embodiments of the present disclosure. For ordinary technical personnel in respective fields, different forms of changes or substitutions can be made based on the above embodiment. It is not necessary and impossible to exhaustively list all implementation modes here. Any modifications, equivalent substitutions, and improvements made within the spirit and principles of the present disclosure shall be included within the protection scope of the claims of the present disclosure.

What is claimed is:

1. A device for flattening a battery cell electrode tab, comprising: a frame (100), a battery cell clamping mechanism (40) provided on the frame (100), and a flattening unit (101) provided on two sides of the battery cell clamping mechanism (40);
wherein the flattening unit (101) comprises:
a guide rail (15),
a sliding support (14),
a flattening mechanism,
a first drive mechanism (10), configured to drive the sliding support (14) to move along the guide rail (15) to approach or move away from the battery cell clamping mechanism (40);
a second drive mechanism (20), configured to drive a rotation shaft (111) to rotate and drive a flattening mechanism to rotate;
a third drive mechanism (30), configured to drive a sliding sleeve (121) to move along the rotation shaft (111) to adjust an angle of the flattening mechanism;
wherein the first drive mechanism (10) is connected to the sliding support (14), the sliding support (14) is slidably connected to the guide rail (15), the second drive mechanism (20) is provided on the sliding support (14) and connected to the flattening mechanism.

2. The device for flattening a battery cell electrode tab according to claim 1, wherein the flattening mechanism comprises a flattening component (103), a rotating component (104), and a movable component (102) configured to adjust an angle of the flattening component (103); the rotating component (104) comprises the rotation shaft (111) and a connection plate (112), the movable component (102) comprises the sliding sleeve (121), a connection rod (122), and an adjustment block (123), the sliding sleeve (121) is movably sleeved on the rotation shaft (111), one end of the connection rod (122) is twisted with an outer wall of the sliding sleeve (121); the third drive mechanism (30) is connected to the sliding sleeve (121), the connection plate (112) and the adjustment block (123) are both L-shape; one side of the connection plate (112) is connected to one end face of the rotation shaft (111), the other end of the rotation shaft (111) is connected to the second drive mechanism (20), a U-shaped opening is provided on the other side of the connection plate (112); the adjustment block (123) comprises a bottom plate (125) and a side plate (124); one end of the side plate (124) that is far away from the bottom plate (125) is hinged with the other end of the connection rod (122), two sides of the bottom plate (125) that are connected to the side plate (124) are rotationally connected to two inner walls of the U-shaped opening, the flattening component (103) passes through the U-shaped opening and is installed on the bottom plate (125) of the adjustment block (123).

3. The device for flattening a battery cell electrode tab according to the claim 2, wherein the connection rod (122) is a U-shaped connection rod, two sides of an end of the side plate (124) that is far from the bottom plate (125) are rotatably connected to two inner walls of an opening end of the U-shaped connection rod, respectively; an outer wall of a sealing end of the U-shaped connection rod is provided with a bending connection part (126) that is hinged with the outer wall of the sliding sleeve (121).

4. The device for flattening a battery cell electrode tab according to claim 2, wherein the flattening component (103) comprises a flattening motor (131) and a flattening cone wheel (132), a base of the flattening motor (131) is fixedly provided on the bottom plate (125), an output shaft of the flattening motor (131) passes through the bottom plate (125) and is connected to the flattening cone wheel (132).

5. The device for flattening a battery cell electrode tab according to claim 2, wherein the first drive mechanism (10) comprises a first motor (11), a first belt transmission component (12), a transmission threaded rod (13), and a transmission shaft (24), a base of the first motor (11) is provided on the frame (100), an output shaft of the first motor (11) is connected to a pulley at one end of the first belt transmission component (12), a pulley at the other end of the first belt transmission component (12) is fixedly connected to one end of the transmission threaded rod (13), two ends of the transmission shaft (24) are connected to a support (25) on the frame (100); the transmission shaft (24) is parallel to the transmission threaded rod (13), the sliding support (14) is thread connection to the transmission threaded rod (13); the sliding support (14) is movably sleeved on the transmission shaft (24).

6. The device for flattening a battery cell electrode tab according to claim 5, wherein the second drive mechanism (20) comprises a second motor (21), a second belt transmission component (22), and a third belt transmission component (23); a base of the second motor (21) is fixed on the frame (100), an output shaft of the second motor (21) is connected to a pulley at one end of the second belt transmission component (22), the transmission shaft (24) passes through the support (25) on a corresponding side and is connected to a pulley at the other end of the second belt transmission component (22), a pulley at one end of the third belt transmission component (23) is movably sleeved on the transmission shaft (24), the third belt transmission component (23) is provided on one side of the sliding support (14) near the second belt transmission component (22), a pulley at the other end of the third belt transmission component (23) is fixedly connected to one end of the rotation shaft (111) away from an adjustment plate (32), the rotation shaft (111) passes through the sliding support (14), a middle of the rotation shaft (111) is rotatably connected to the sliding support (14).

7. The device for flattening a battery cell electrode tab according to claim 6, wherein the third drive mechanism (30) comprises a third motor (31), an adjustment threaded rod (33), and the adjustment plate (32), one side of the sliding support (14) that is opposite to the flattening mechanism is provided with a motor bracket (34), a base of the third motor (31) is fixed on the motor bracket (34), an output shaft of the third motor (31) is connected to one end of the adjustment threaded rod (33), the other end of the adjustment threaded rod (33) is thread connection to the adjustment plate (32); one side of the adjustment plate (32) is rotatably connected to the sliding sleeve (121), an output shaft of the third motor (31) is parallel to the rotation shaft (111).

8. The device for flattening a battery cell electrode tab according to claim 7, wherein the other end of the adjustment threaded rod (33) is further provided with a limit structure configured to limit the adjustment plate (32).

9. The device for flattening a battery cell electrode tab according to claim 7, wherein the outer wall of the sliding sleeve (121) is provided with an annular groove (127), one side of the adjustment plate (32) is provided with an arc-shaped notch, the arc-shaped notch is sleeved on the annular groove (127) and rotatably connected to the outer wall of the sliding sleeve (121).

10. The device for flattening a battery cell electrode tab according to claim 1, wherein the battery cell clamping mechanism (40) comprises a clamping cylinder (41), a support block (43), and a clamping block (42) that cooperates with the support block (43) to clamp the battery cell (200), the clamping cylinder (41) is provided on the frame (100), a telescopic rod of the clamping cylinder (41) is connected to the clamping block (42), the clamping block faces to the support block (43).
